(19) United States
(12) Patent Application Publication
(10) Pub. No.: US 2021/0264625 A1
(43) Pub. Date: Aug. 26, 2021

(54) STRUCTURED LIGHT CODE OVERLAY

(71) Applicant: QUALCOMM Incorporated, San Diego, CA (US)

(72) Inventors: Kalin Mitkov ATANASSOV, San Diego, CA (US); James Wilson NASH, San Diego, CA (US); Stephen Michael VERRALL, Carlsbad, CA (US)

(21) Appl. No.: 17/079,364

(22) Filed: Oct. 23, 2020

Related U.S. Application Data
(60) Provisional application No. 62/981,969, filed on Feb. 26, 2020.

(51) Int. Cl. G06T 7/521; G06T 7/55

(52) U.S. Cl. CPC G06T 7/521; G06T 2207/10028; G06T 7/55

(57) ABSTRACT

Techniques and systems are provided for generating one or more depth maps. For example, a process can include transmitting a pattern of light using a structured light source, the pattern of light including at least a first sub-pattern group of a primitive pattern and a second sub-pattern group of the primitive pattern. The process can include generating an overlapped pattern of light, the overlapped pattern of light including at least the first sub-pattern group of the primitive pattern overlapped with the second sub-pattern group of the primitive pattern. The process can include receiving one or more return signals based on the overlapped pattern of light. The process can include generating a depth map based on the one or more return signals.

### CROSS-REFERENCE TO RELATED APPLICATIONS

This application claims the benefit of U.S. Provisional Application No. 62/981,969, filed Feb. 26, 2020, which is hereby incorporated by reference, in its entirety and for all purposes.

### FIELD

This application is related to depth sensing systems. In some cases, systems, apparatuses, methods, and computer-readable media are described that provide improved structured light technologies.

### SUMMARY

Systems and techniques are described for providing a structured light code overlay for a structured light system. In one illustrative example, a method of generating one or more depth maps is provided. The method includes: transmitting a pattern of light using a structured light source, the pattern of light including at least a first sub-pattern group of a primitive pattern and a second sub-pattern group of the primitive pattern; generating an overlapped pattern of light, the overlapped pattern of light including at least the first sub-pattern group of the primitive pattern overlapped with the second sub-pattern group of the primitive pattern; receiving one or more return signals based on the overlapped pattern of light; and generating a depth map based on the one or more return signals.

In another example, an apparatus for generating one or more depth maps is provided that includes a memory; a structured light source configured to transmit a pattern of light, the pattern of light including at least a first sub-pattern group of a primitive pattern and a second sub-pattern group of the primitive pattern; an optical device configured to generate an overlapped pattern of light, the overlapped pattern of light including at least the first sub-pattern group of the primitive pattern overlapped with the second sub-pattern group of the primitive pattern; and one or more processors (e.g., implemented in circuitry) coupled to the memory. The one or more processors are configured to: obtain one or more return signals based on the overlapped pattern of light; and generate a depth map based on the one or more return signals.

In another example, a non-transitory computer-readable medium is provided that has stored thereon instructions that, when executed by one or more processors, cause the one or more processor to: cause an overlapped pattern of light to be emitted based on a pattern of light transmitted by a structured light source, the pattern of light including at least a first sub-pattern group of a primitive pattern and a second sub-pattern group of the primitive pattern, and the overlapped pattern of light including at least the first sub-pattern group of the primitive pattern overlapped with the second sub-pattern group of the primitive pattern; obtain one or more return signals based on the overlapped pattern of light; and generate a depth map based on the one or more return signals.

In another example, an apparatus for generating one or more depth maps is provided. The apparatus includes: means for transmitting a pattern of light using a structured light source, the pattern of light including at least a first sub-pattern group of a primitive pattern and a second sub-pattern group of the primitive pattern; means for generating an overlapped pattern of light, the overlapped pattern of light including at least the first sub-pattern group of the primitive pattern overlapped with the second sub-pattern group of the primitive pattern; means for receiving one or more return signals based on the overlapped pattern of light; and means for generating a depth map based on the one or more return signals.

In some aspects, the pattern of light is based on light generated by the structured light source and passed through a lens configured to collimate the light generated by the structured light source. In such aspects, the apparatus can include the lens configured to collimate the light generated by the structured light source.

In some aspects, generating the overlapped pattern of light includes tessellating the pattern of light using a diffractive optical element configured to replicate the pattern of light. In such aspects, the optical device of the apparatus can be the diffractive optical element.

In some aspects, the pattern of light includes the first sub-pattern group of the primitive pattern, the second sub-pattern group of the primitive pattern, a third sub-pattern group of the primitive pattern, and a fourth sub-pattern group of the primitive pattern. In such aspects, generating the overlapped pattern of light can include overlapping the first sub-pattern group of the primitive pattern with the second sub-pattern group of the primitive pattern, the third sub-pattern group of the primitive pattern, and the fourth sub-pattern group of the primitive pattern. For example, the optical device (e.g., the diffractive optical element) can be configured to generate the overlapped pattern of light at least in part by overlapping the first sub-pattern group of the primitive pattern with the second sub-pattern group of the primitive pattern, the third sub-pattern group of the primitive pattern, and the fourth sub-pattern group of the primitive pattern.

In some aspects, the one or more return signals include a received image of the overlapped pattern of light. In such aspects, the depth map can be derived from the received image of the overlapped pattern of light.

In some aspects, the structured light source includes a regular grid of light emitting sources.

In some examples, the apparatus is, or is part of, a mobile device (e.g., a mobile telephone or so-called “smart phone” or other mobile device), a camera, a wearable device, an extended reality device (e.g., a virtual reality (VR) device, an augmented reality (AR) device, or a mixed reality (MR) device), a personal computer, a laptop computer, a server computer, a vehicle (or computing device of a vehicle), or other device. In some aspects, the apparatus includes a camera or multiple cameras for capturing one or more images. In some aspects, the apparatus further includes a display for displaying one or more images, notifications, and/or other displayable data. In some aspects, the apparatus can include one or more sensors (e.g., one or more accelerometers, gyroscopes, inertial measurement units (IMUs), motion detection sensors, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example of a system including an array of lasers, in accordance with some examples;

FIG. 2 is a block diagram illustrating another example of a system including an array of lasers, in accordance with some examples;

FIG. 3A is a block diagram illustrating another example of a system including an array of lasers, in accordance with some examples;

FIG. 3B is a block diagram illustrating another example of a system including an array of lasers, in accordance with some examples;

FIG. 4A is a diagram illustrating an example of a primitive pattern, in accordance with some examples;

FIG. 4B is a diagram illustrating an example of a projected pattern and a tessellated coded pattern of light, in accordance with some examples;

FIG. 5A is a diagram illustrating an example of a primitive pattern, in accordance with some examples;

FIG. 5B is a diagram illustrating an example of a split primitive pattern, in accordance with some examples;

FIG. 5C is a diagram illustrating an example of a projected pattern and a tessellated coded pattern of light, in accordance with some examples;

FIG. 5D is a diagram illustrating an example of overlapping sub-pattern groups of a split primitive pattern, in accordance with some examples;

FIG. 6A is a diagram illustrating an example of patterns used for a structured light code overlay, in accordance with some examples;

FIG. 6B is a diagram illustrating an example of patterns used for a structured light code overlay, in accordance with some examples;

FIG. 6C is a diagram illustrating an example of patterns used for a structured light code overlay, in accordance with some examples;

FIG. 6D is a diagram illustrating an example of patterns used for a structured light code overlay, in accordance with some examples;

FIG. 7 is a flowchart illustrating an example of a process for generating one or more depth maps, in accordance with some examples; and

FIG. 8 illustrates an example computing device architecture of an example computing device which can implement the various techniques described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Various systems and/or applications make use of three-dimensional (3D) information representing a scene, such as systems and/or applications that perform face recognition, authentication systems that uses a subject's face identification (ID), object scanning, autonomous driving, robotics navigation and/or object detection, aviation navigation (e.g., for unmanned aerial vehicles, airplanes, among others), indoor navigation, augmented reality (AR), 3D scene understanding, object grasping, object tracking, among other tasks. Recent needs to capture 3D information from a scene (e.g., for face ID, object scanning, autonomous driving, AR applications, among others) have created a high demand for active depth sensing technologies.

Structured light technology is one example that offers a reliable and high quality depth capture system. In general, a structured light system can include a structured light sensor or other device for scanning and/or determining the dimensions and/or movement of a scene and/or one or more objects (e.g., a person, a device, an animal, a vehicle, etc.) in the scene. The structured light sensor or device can project a known shape or pattern of light onto the scene including the one or more objects, and can determine the dimensions and/or movement of the scene (e.g., the dimensions and/or movement of the one or more objects within the scene) based on measured or detected deformations of the shape or pattern.

In some cases, a structured light system can project a configurable pattern of light. The structured light system can include at least one transmitter and at least one receiver. A transmitter of the structured light system can project or transmit a distribution of light points onto a target object. The projected light can include a plurality of light points or other shapes, and in some cases can be focused into any suitable size and dimensions. For example, the light may be projected in lines, squares, or any other suitable shape and/or dimension. As noted above, a structured light system can act as a depth sensing system that can be used to generate a depth map of a scene.

In some example implementations, the light projected by the transmitter of a structured light system can be infrared (IR) light. IR light can include portions of the visible light spectrum (e.g., near-infrared (NIR) light) and/or portions of the light spectrum that are not visible to the human eye (e.g., IR light outside of the NIR spectrum). For instance, IR light may include NIR light, which may or may not include light within the visible light spectrum. In some cases, other suitable wavelengths of light may be transmitted by the structured light system. For example, light can be transmitted by the structured light system in the ultraviolet light spectrum, the microwave spectrum, radio frequency spectrum, visible light spectrum, and/or other suitable light signals. In some cases, the light can be transmitted through an optical element (e.g., a lens and/or other element).

Many structured light system are based on a single light (e.g., a single laser) that forms the desired coded light pattern. However, a single laser typically cannot provide enough power to make the system work reliably (e.g., for outdoor scenes). An alternative to single light structured light system is an array based structured light system that uses an array of lights (e.g., an array of lasers), which can have multiple times the power of a single light structured light system. For instance, an array based structured light system can include an array of a certain number of light emitting lasers, with each light emitting laser emitting IR light (e.g., in response to an electrical drive signal applied to an electrical input of each of the light emitting lasers). One example of a multi-light structured light system is a Vertical-cavity surface-emitting laser (VCSel) array. For instance, a VCSel array can include an array of VCSels, with each VCSel emitting IR light.

A structured light system ideally provides a high resolution coded depth pattern without consuming large amounts of power. For example, the depth pattern should have sufficient resolution to enable the system to accurately determine a depth map that can then be used to determine a 3D shape of an object. In producing such a depth pattern, the system should be able to limit the consumption of power such that power level of a battery powering the device including the system is not unnecessarily depleted. Using an array based structured light system (e.g., a VCSel array) to achieve a high resolution coded depth pattern with sufficient power can require an optical path length (corresponding to transmitter height) that is not practical for some devices. For example, for mobile devices (e.g., smartphones), a transmitter height needs to be less than 5 millimeters (<5 mm), while a transmitter height of 7-8 mm is needed to achieve a high resolution coded depth pattern with sufficient power.

Options exist to achieve high resolution coded patterns within power constraints, each being associated with certain cost. One example is to reduce the coded pattern resolution, in which case the depth map resolution (corresponding to the quality of the depth map) is reduced as well. Another option is to reduce the array size of an array based structured light system (e.g., of the VCSel array). For example, when the array size is reduced, each light source of the array (e.g., each VCSel) can occupy a smaller silicon area. When the array size is reduced, overheating may prevent the array (e.g., the VCSel array) from being run at the necessary power. Another option is to fold the optical path to reduce height. Such a solution that folds the optical path requires additional components, such as prisms. A system that folds the optical path includes a complicated and costly transmitter. For example, the transmitter is wider (the optical path is folded but not reduced) in a system that is configured to fold the optical path.

Methods (also referred to as processes), systems, apparatuses, and computer-readable media (collectively referred to as “systems and techniques”) are described herein that provide improved structured light technologies. In some examples, an improved structured light system can be provided using a structured light code overlay. In some implementations, the systems and techniques described herein can be used for depth sensing to generate depth maps for various applications, such as in 3D imaging for object recognition (e.g., face recognition etc.), autonomous driving systems, gesture recognition, robotics systems, aviation systems, among others. The structured light based depth sensing described herein refers to active depth sensing for which a light source transmits multiple instances of focused light in a predefined distribution or pattern. A distribution of light may include a distribution of points of light, arcs of light, or another suitable shape of each focused light instance. A light distribution can be defined such that the location of each light instance within the distribution or pattern is known by the device before emission. Aspects of the application refer to a distribution of light as a distribution of light points to illustrate aspects of the disclosure, but any suitable shape of the light instances and any suitable distribution of the light instances may be used.

In some implementations, the light pattern (e.g., the points of light) may be projected onto a scene, and the reflections of the points of light (along with other light) may be received by a receiver of the active depth sensing system. Depths of objects in a scene can be determined by comparing the pattern of the received light and the pattern of the transmitted light. For example, in comparing the patterns, a portion of the predefined distribution of the transmitted light may be identified in the received light. The locations of the portions and any skew or stretching of the portions of the distribution identified in the received light can be used to determine depths of one or more objects in the scene.

As described in more detail below, the systems and techniques described herein can provide a structured light code overlay by splitting a coded primitive (including a pattern of light) into a number of sub-pattern groups (e.g., four sub-pattern groups). A sub-pattern group can also be referred to herein as a group or a quadrant. The systems and techniques can generate a split primitive pattern (also referred to as a mask pattern) that includes the sub-pattern groups from the primitive. A structured light source of a transmitter can be designed to include an array of light emitters arranged in the split primitive pattern. A diffractive optical element (e.g., including a template) of the transmitter can be used to overlap the sub-pattern groups of the split primitive pattern to produce an overlapped coded pattern (also referred to as an overlapped pattern). For example, light projected using the structured light source according to the split primitive pattern can pass through the diffractive optical element, which can overlap the sub-pattern groups to produce the overlapped coded pattern. In some cases, the diffractive optical element can overlap the sub-pattern groups in multiple directions, resulting in the projected split primitive pattern being replicated (or tessellated) in order to fill in a field of view (FOV) of the transmitter. The overlapped coded pattern has the same pattern as the coded primitive repeated a number of times according to the design of the diffractive optical element. Using such a technique, the lens focal distance and thus the transmitter size can be reduced by an amount determined by the number of sub-pattern groups (e.g., using four quadrants, the lens focal distance can be cut in half, such as from 6 mm to 3 mm). Further details regarding the systems and techniques will be described with reference to the figures.

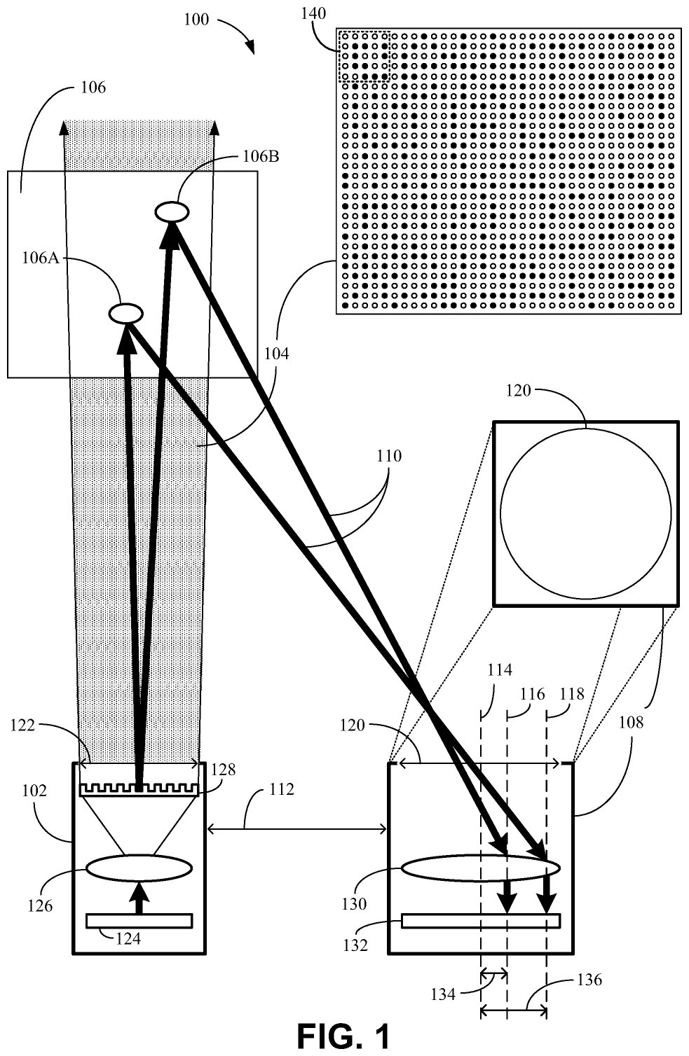

FIG. 1 is a depiction of an example active depth sensing system 100 configured to use a distribution of light for determining depths of objects 106A and 106B in a scene 106. The active depth sensing system 100 may be used to generate a depth map (not pictured) of the scene 106. For example, the scene 106 may include an object (e.g., a face), and the active depth sensing system 100 may be used to generate a depth map including a plurality of depth values indicating depths of portions of the object for identifying or authenticating the object (e.g., for face authentication). The active depth sensing system 100 includes a projector 102 and a receiver 108. The projector 102 may be referred to as a “structured light source”, “transmitter,” “emitter,” “light source,” or other similar term, and should not be limited to a specific transmission component. Throughout the following disclosure, the terms projector, transmitter, and light source may be used interchangeably. The receiver 108 may be referred to as a “detector,” “sensor,” “sensing element,” “photodetector,” and so on, and should not be limited to a specific receiving component.

The projector 102 may be configured to project or transmit a distribution 104 of light points onto the scene 106. The white circles in the distribution 104 indicate where no light is projected for a possible point location, and the black circles in the distribution 104 indicate where light is projected for a possible point location. The disclosure may refer to the distribution 104 as a codeword distribution or a pattern, where defined portions of the distribution 104 are codewords (also referred to as codes). As used herein, a codeword is a rectangular (such as a square) portion of the distribution 104 of light. For example, a 5×5 codeword 140 is illustrated in the distribution 104. As shown, the codeword 140 includes five rows of possible light points and five columns of possible light points. The distribution 104 may be configured to include an array of codewords. For active depth sensing, the codewords may be unique from one another in the distribution 104. For example, codeword 140 is different than all other codewords in the distribution 104. Further, the location of unique codewords with reference to one another is known. In this manner, one or more codewords in the distribution may be identified in reflections, and the location of the identified codewords with reference to one another, the shape or distortion of the identified codewords with reference to the shape of the transmitted codeword, and the location of the identified codeword on a receiver sensor are used to determine a depth of an object in the scene reflecting the codeword.

The projector 102 includes one or more light sources 124 (such as one or more lasers). In some implementations, the one or more light sources 124 includes a laser array. In one illustrative example, each laser may be a vertical cavity surface emitting laser (VCSel). In another illustrative example, each laser may include a distributed feedback (DFB) laser. In another illustrative example, the one or more light sources 124 may include a resonant cavity light emitting diodes (RC-LED) array. In some implementations, the projector may also include a lens 126 and a light modulator 128. The projector 102 may also include an aperture 122 from which the transmitted light escapes the projector 102. In some implementations, the projector 102 may further include a diffractive optical element (DOE) to diffract the emissions from one or more light sources 124 into additional emissions. In some aspects, the light modulator 128 (to adjust the intensity of the emission) may include a DOE. In projecting the distribution 104 of light points onto the scene 106, the projector 102 may transmit one or more lasers from the light source 124 through the lens 126 (and/or through a DOE or light modulator 128) and onto objects 106A and 106B in the scene 106. The projector 102 may be positioned on the same reference plane as the receiver 108, and the projector 102 and the receiver 108 may be separated by a distance called the baseline 112.

In some example implementations, the light projected by the projector 102 may be infrared (IR) light. IR light may include portions of the visible light spectrum and/or portions of the light spectrum that is not visible to the naked eye. In one example, IR light may include near infrared (NIR) light, which may or may not include light within the visible light spectrum, and/or IR light (such as far infrared (FIR) light) which is outside the visible light spectrum. The term IR light should not be limited to light having a specific wavelength in or near the wavelength range of IR light. Further, IR light is provided as an example emission from the projector. In the following description, other suitable wavelengths of light may be used. For example, light in portions of the visible light spectrum outside the IR light wavelength range or ultraviolet light may be used.

The scene 106 may include objects at different depths from the structured light system (such as from the projector 102 and the receiver 108). For example, objects 106A and 106B in the scene 106 may be at different depths. The receiver 108 may be configured to receive, from the scene 106, reflections 110 of the transmitted distribution 104 of light points. To receive the reflections 110, the receiver 108 may capture a frame. When capturing the frame, the receiver 108 may receive the reflections 110, as well as (i) other reflections of the distribution 104 of light points from other portions of the scene 106 at different depths and (ii) ambient light. Noise may also exist in the capture.

In some example implementations, the receiver 108 may include a lens 130 to focus or direct the received light (including the reflections 110 from the objects 106A and 106B) on to the sensor 132 of the receiver 108. The receiver 108 also may include an aperture 120. Assuming for the example that only the reflections 110 are received, depths of the objects 106A and 106B may be determined based on the baseline 112, displacement and distortion of the light distribution 104 (such as in codewords) in the reflections 110, and intensities of the reflections 110. For example, the distance 134 along the sensor 132 from location 116 to the center 114 may be used in determining a depth of the object 106B in the scene 106. Similarly, the distance 136 along the sensor 132 from location 118 to the center 114 may be used in determining a depth of the object 106A in the scene 106. The distance along the sensor 132 may be measured in terms of number of pixels of the sensor 132 or a unit of distance (such as millimeters).

In some example implementations, the sensor 132 may include an array of photodiodes (such as avalanche photodiodes) for capturing a frame. To capture the frame, each photodiode in the array may capture the light that hits the photodiode and may provide a value indicating the intensity of the light (a capture value). The frame therefore may be an array of capture values provided by the array of photodiodes.

In addition or alternative to the sensor 132 including an array of photodiodes, the sensor 132 may include a complementary metal-oxide semiconductor (CMOS) sensor. To capture the image by a photosensitive CMOS sensor, each pixel of the sensor may capture the light that hits the pixel and may provide a value indicating the intensity of the light. In some example implementations, an array of photodiodes may be coupled to the CMOS sensor. In this manner, the electrical impulses generated by the array of photodiodes may trigger the corresponding pixels of the CMOS sensor to provide capture values.

The sensor 132 may include at least a number of pixels equal to the number of possible light points in the distribution 104. For example, the array of photodiodes or the CMOS sensor may include at least a number of photodiodes or a number of pixels, respectively, corresponding to the number of possible light points in the distribution 104. The sensor 132 logically may be divided into groups of pixels or photodiodes that correspond to a size of a bit of a codeword (such as 4×4 groups for a 4×4 codeword). The group of pixels or photodiodes also may be referred to as a bit, and the portion of the captured data from a bit of the sensor 132 also may be referred to as a bit. In some example implementations, the sensor 132 may include at least the same number of bits as the distribution 104. If the light source 124 transmits IR light (such as NIR light at a wavelength of, e.g., 940 nanometers (nm)), the sensor 132 may be an IR sensor to receive the reflections of the NIR light.

As illustrated, the distance 134 (corresponding to the reflections 110 from the object 106B) is less than the distance 136 (corresponding to the reflections 110 from the object 106A). Using triangulation based on the baseline 112 and the distances 134 and 136, the differing depths of objects 106A and 106B in the scene 106 may be determined in generating a depth map of the scene 106. Determining the depths may further be based on a displacement or a distortion of the distribution 104 in the reflections 110.

In some implementations, the projector 102 is configured to project a fixed light distribution, in which case the same distribution of light is used in every instance for active depth sensing. In some implementations, the projector 102 is configured to project a different distribution of light at different times. For example, the projector 102 may be configured to project a first distribution of light at a first time and project a second distribution of light at a second time. A resulting depth map of one or more objects in a scene is thus based on one or more reflections of the first distribution of light and one or more reflections of the second distribution of light. The codewords between the distributions of light may differ, and the active depth sensing system 100 may be able to identify a codeword in the second distribution of light corresponding to a position in the first distribution of light for which the codeword could not be identified. In this manner, more valid depth values may be generated in generating the depth map without reducing the resolution of the depth map (such as by increasing the size of the codewords).

Although a number of separate components are illustrated in FIG. 1, one or more of the components may be implemented together or include additional functionality. All described components may not be required for an active depth sensing system 100, or the functionality of components may be separated into separate components. Additional components not illustrated also may exist. For example, the receiver 108 may include a bandpass filter to allow signals having a determined range of wavelengths to pass onto the sensor 132 (thus filtering out signals with a wavelength outside of the range). In this manner, some incidental signals (such as ambient light) may be prevented from being received as interference during the captures by the sensor 132. The range of the bandpass filter may be centered at the transmission wavelength for the projector 102. For example, if the projector 102 is configured to transmit NIR light with a wavelength of 940 nm, the receiver 108 may include a bandpass filter configured to allow NIR light having wavelengths within a range of, e.g., 920 nm to 960 nm. Therefore, the examples described regarding FIG. 1 is for illustrative purposes.

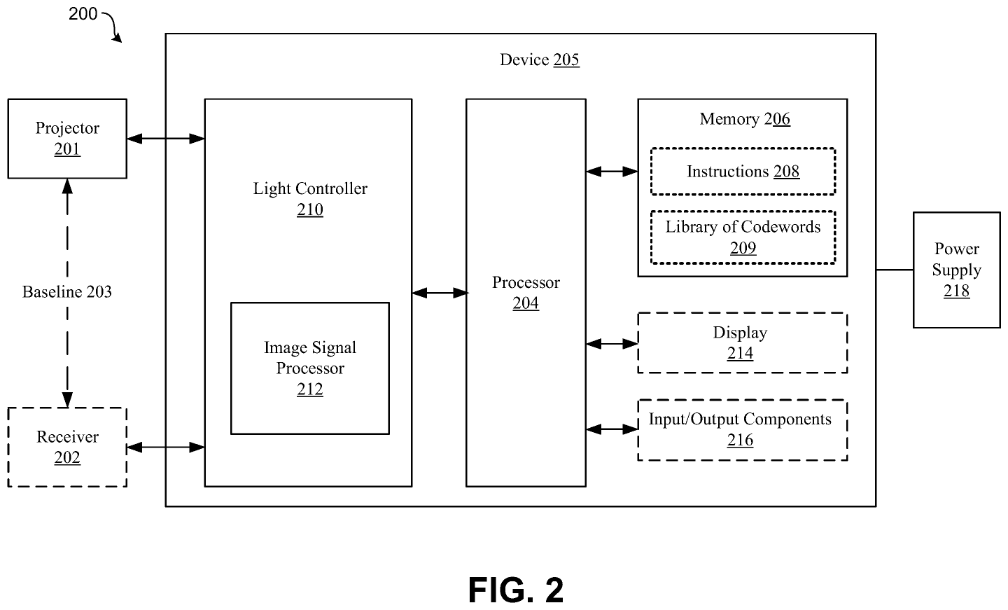

FIG. 2 is a block diagram illustrating an example of a system 200 including a device 205 and a projector 201 configured to emit different distributions of light for active depth sensing. In some examples, the projector 201 can be part of the device 205. In some other examples, a transmitter may be separate from and coupled to the device 205. The example device 205 may include or be coupled to a projector 201 and a receiver 202 separated from the projector 201 by a baseline 203. The receiver 202 may be an IR sensor configured to capture frames, and the projector 201 may be a projector configured to project two or more different distributions of light. The receiver 202 can be part of the device 205, or can be separate from and coupled to the device 205.

The example device 205 also may include a processor 204, a memory 206 storing instructions 208, and a light controller 210 (which may include one or more image signal processors 212). The device 205 may optionally include (or be coupled to) a display 214 and a number of input/output (I/O) components 216. The device 205 may include additional features or components not shown. For example, a wireless interface, which may include a number of transceivers and a baseband processor, may be included for a wireless communication device to perform wireless communications. In another example, the device 205 may include one or more cameras (such as a contact image sensor (CIS) camera or other suitable camera for capturing images using visible light). The projector 201 and the receiver 202 may be part of an active depth sensing system (such as the system 100 in FIG. 1) controlled by the light controller 210 and/or the processor 204. The device 205 may include or be coupled to additional light projectors (or a flood illuminator) or may include a different configuration for the light projectors. The device 205 also may include or be coupled to additional receivers (not shown) for capturing multiple frames of a scene. The disclosure is not to be limited to any specific examples or illustrations, including the example device 205.

The memory 206 may be a non-transient or non-transitory computer readable medium storing computer-executable instructions 208 to perform all or a portion of one or more operations described in this disclosure. If the light distribution projected by the projector 201 is divided into codewords, the memory 206 optionally may store a library of codewords 209 for the distribution of light including the plurality of codewords in the library of codewords 209. The library of codewords 209 may indicate what codewords exist in the distribution and the relative location between the codewords in the distribution. The device 205 may use the library of codewords 209 to identify codewords in one or more reflections within captures from the receiver 202. The device 205 also may include a power supply 218, which may be coupled to or integrated into the device 205.

The processor 204 may be one or more suitable processors capable of executing scripts or instructions of one or more software programs (such as instructions 208 stored within the memory 206). In some aspects, the processor 204 may be one or more general purpose processors that execute instructions 208 to cause the device 205 to perform any number of functions or operations. In additional or alternative aspects, the processor 204 may include integrated circuits or other hardware to perform functions or operations without the use of software. In some implementations, the processor 204 includes one or more application processors to execute applications stored in executable instructions 208. For example, if the device 205 is a smartphone or other computing device, the processor 204 may execute instructions for an operating system of the device 205, and the processor 204 may provide instructions to the light controller 210 for controlling the active depth sensing system.

While shown to be coupled to each other via the processor 204 in the example of FIG. 2, the processor 204, the memory 206, the light controller 210, the optional display 214, and the optional I/O components 216 may be coupled to one another in various arrangements. For example, the processor 204, the memory 206, the light controller 210, the optional display 214, and/or the optional I/O components 216 may be coupled to each other via one or more local buses (not shown for simplicity).

The display 214 may be any suitable display or screen allowing for user interaction and/or to present items (such as a depth map, a preview image of a scene, a lock screen, etc.) for viewing by a user. In some aspects, the display 214 may be a touch-sensitive display. The I/O components 216 may be or include any suitable mechanism, interface, or device to receive input (such as commands) from the user and to provide output to the user. For example, the I/O components 216 may include (but are not limited to) a graphical user interface, keyboard, mouse, microphone and speakers, squeezable bezel or border of the device 205, physical buttons located on device 205, and so on. The display 214 and/or the I/O components 216 may provide a preview image or depth map of the scene to a user and/or receive a user input for adjusting one or more settings of the device 205.

The light controller 210 may include a signal processor 212, which may be one or more processors to configure the projector 201 and process frames captured by the receiver 202. In some aspects, the image signal processor 212 may execute instructions from a memory (such as instructions 208 from the memory 206 or instructions stored in a separate memory coupled to the image signal processor 212). In other aspects, the image signal processor 212 may include specific hardware for operation. The image signal processor 212 may alternatively or additionally include a combination of specific hardware and the ability to execute software instructions.

In some implementations, the processor 204 may be configured to provide instructions to the image signal processor 212. The instructions may be executed by the image signal processor 212 to configure filters or other components of an image processing pipeline for processing frames from the receiver 202. The instructions may also be executed by the image signal processor 212 to configure the projector 201 for projecting one or more distributions of light for active depth sensing. While the following aspects of the disclosure may be described in relation to the device 205, any suitable device or configuration of device components may be used for performing aspects of the disclosure, and the present disclosure is not limited by a specific device configuration.

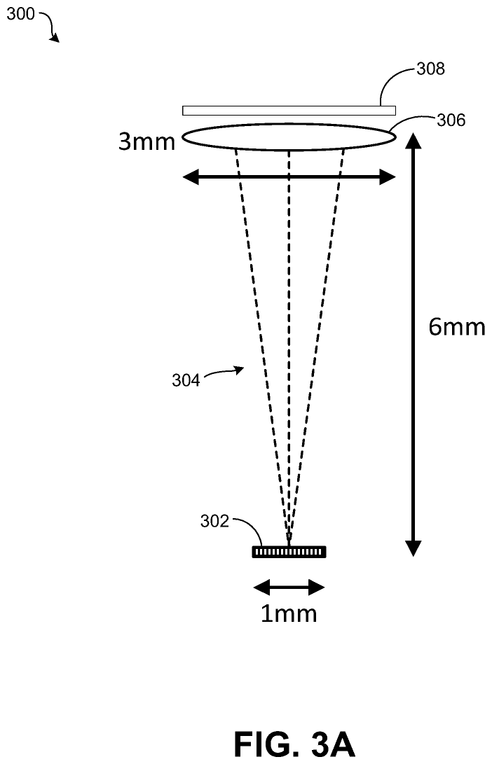

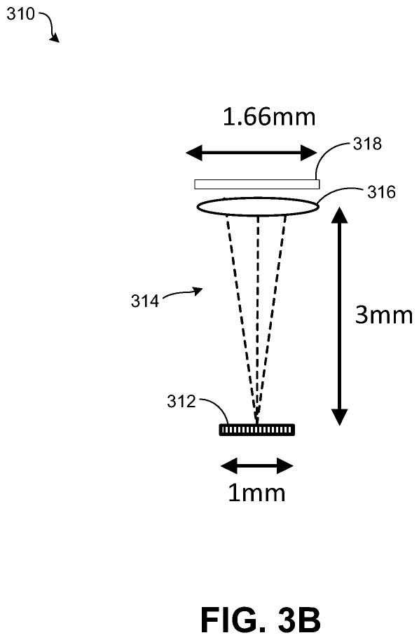

FIG. 3A illustrates an example of a simplified structured light system 300. In some cases, the system 300 can include a transmitter that is part of a larger structured light system or device. In some cases, the structured light system 300 can be implemented as part of the system 100 or the system 200. In some implementations, the system 300 can be used for depth sensing to generate depth maps for various applications, such as in 3D imaging for object recognition (e.g., face recognition etc.), autonomous driving systems (e.g., for navigation or other task), gesture recognition, robotics systems, aviation systems, among others. The system 300 includes an array 302 of light emitting sources (also referred to as light emitters). The array 302 can also be referred to as a structured light source. In some cases, the array 302 can include multiple arrays. In some examples, the array 302 of light emitting sources can include a surface-emitting array of light emitters (e.g., a VCSel array or other suitable array) that generates optical beams of light 304 from a surface of a device or component (e.g., a substrate or wafer) of a device. While the array 302 illustrated in FIG. 3A is shown having a length of 1 mm as an illustrative example, one of ordinary skill will appreciate that the array 302 can include any other suitable length (e.g., 0.5 mm, 1.5 mm, 2 mm, or other length).

In some cases, the array 302 (e.g., as a surface-emitting array) can be an addressable array, in which individual elements of the array (or in some cases groups of elements in the array) are independently electrically controlled. For example, a light emitting source of the surface-emitting array can be connected to a photodiode (e.g., through a fiber connection or other connection). A pulse voltage can be applied to a base of a transistor (e.g., a bipolar junction transistor), causing a laser current to pulsate and the light emitting source to have a corresponding output power. An example of an addressable surface-emitting array is a VCSel array, a resonant cavity light emitting diodes (RC-LED) array, among others.

The optical beams of light 304 generated and transmitted by the array 302 of light emitting sources can be projected in one or more spatial patterns onto a surface of an object or other surface. The spatial pattern can include any type of pattern, such as a pattern that includes spots or dots, stripes, fringe, squares, and/or another other shape. The spatial patterns may be regular (e.g., with a fixed pattern of shapes) or irregular (e.g., with a non-fixed pattern of shapes). The spatial pattern can be provided in one or two dimensions.

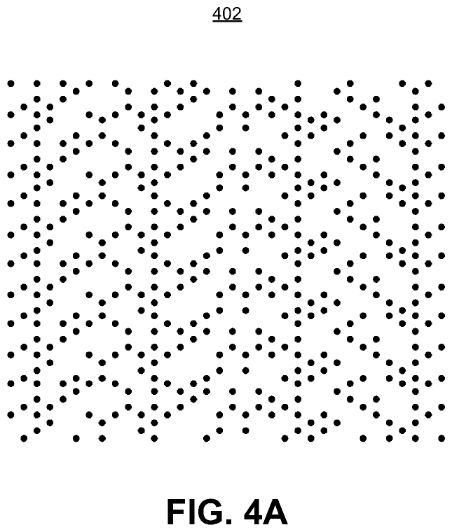

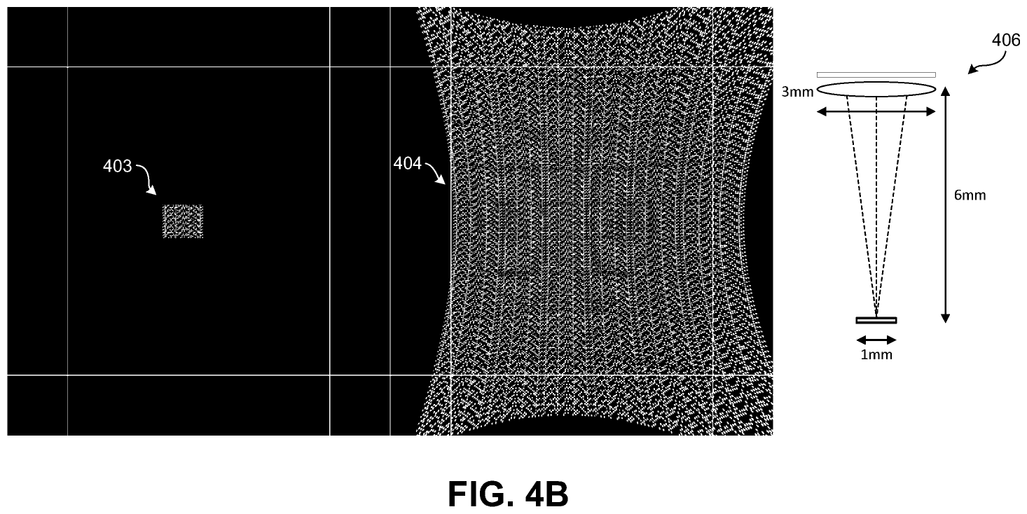

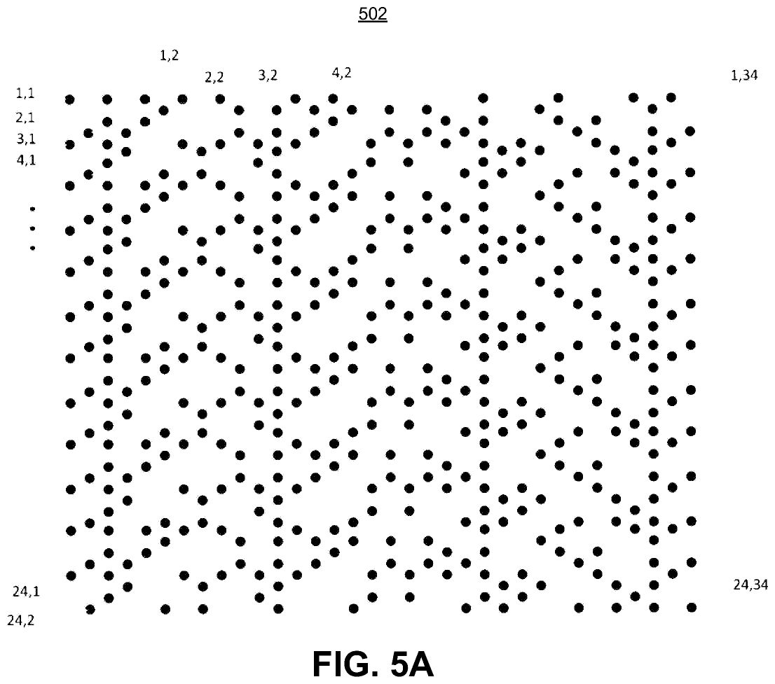

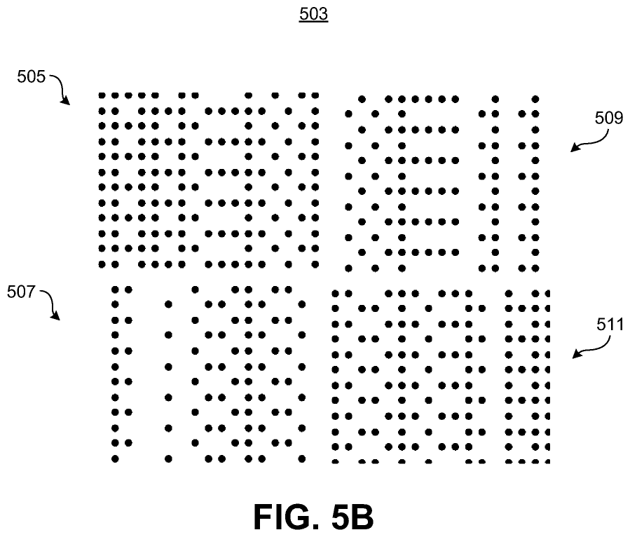

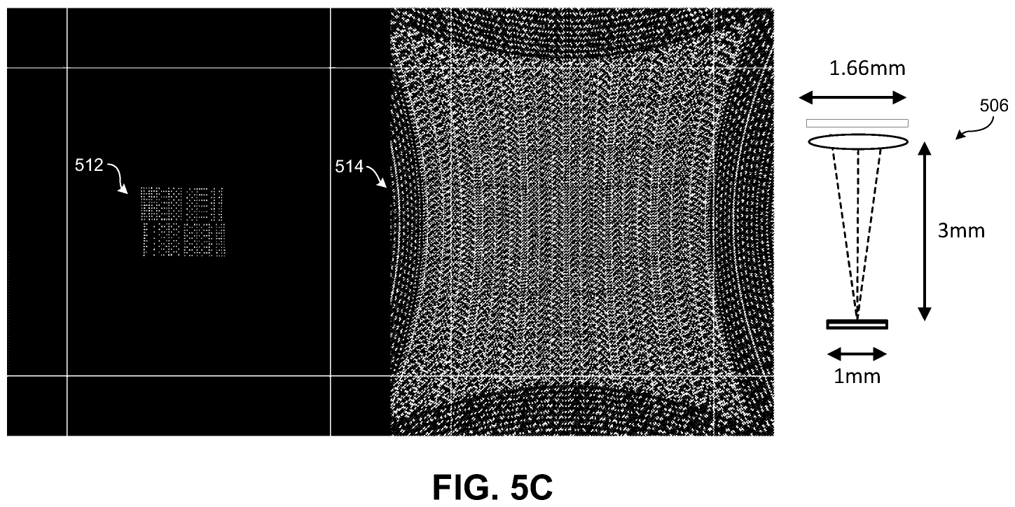

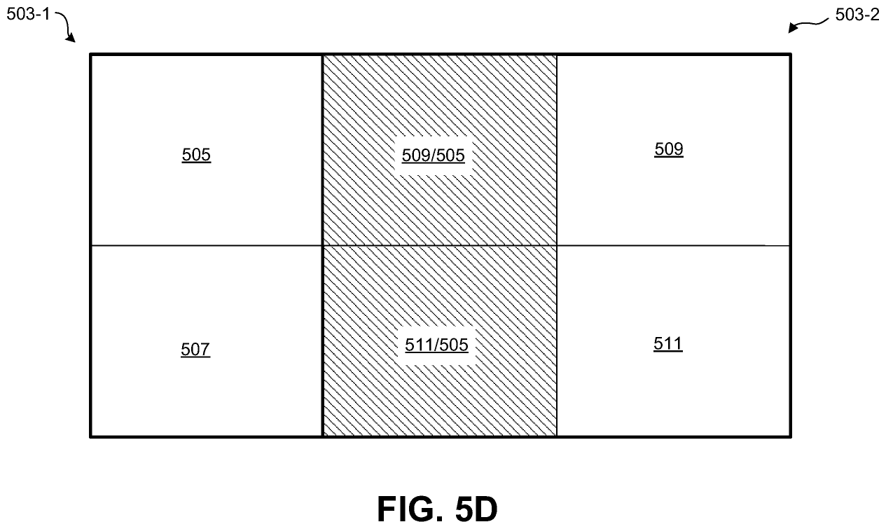

In some examples, the array 302 of light emitting sources can provide the desired coded primitive pattern (e.g., with enough points to disambiguate depth). For instance, the configuration of light emitting sources in the array 302 can be used to define the primitive pattern. In some examples, the primitive pattern can be defined by a pattern diffractive optical element (DOE), not shown in FIG. 3A. The beams of emitted light from the array 302 (or from the pattern DOE in examples where a pattern DOE is used to define the coded pattern) can be collimated (or aligned) with a lens 306. The longer the focal length of the lens, the higher the resolution of the projected pattern (e.g., as illustrated by the projected pattern 403 in FIG. 4B relative to the projected pattern 512 in FIG. 5C, explained in more detail below).

A coded primitive pattern can include a plurality of spatially-coded and unique codes within a certain symbol structure (an n1-by-n2 symbol structure). A primitive pattern can be defined from a subset of all possible codes (e.g., combinations of symbols that are possible within the symbol structure). An example of a 24×34 primitive pattern is the primitive pattern 402 shown in FIG. 4A and FIG. 4B and the primitive pattern 502 shown in FIG. 5A. As described in more detail below, the primitive pattern be used to generate a coded pattern. The array 302 can have a regular grid (e.g., a square grid, a hexagonal grid, or a grid having another shape) of light emitting sources that are used to generate the codes. In some cases, a certain number of potential points on the grid can be activated (or turned on). In one illustrative example, a mask pattern can be generated using a regular grid to generate the codes of a coded pattern by turning on approximately 52% of the potential points of the grid. In some examples, the mask pattern (e.g., the activated light emitting sources) does not change temporally and is temporally fixed. Multiple points from the grid form a code. In one illustrative example, a 4×4 group of points (16 points total) can form a code. As noted above, in some cases, not all points (e.g., not all 16 points from the example above) will be turned on or activated, in which case multiple codes (or primitives) can be formed within the mask with strict properties.

In some cases, as shown in FIG. 3A, a single lens 306 can be used to collimate or align the light beams from the array 302 of light emitting sources. In some cases, a separate microlens can be provided for each light emitting source. In such cases, each microlens can be used to collimate a light beam from a respective light emitting source (e.g., a first microlens for collimating a first light beam from a first light emitting source of the array 302, a second microlens for collimating a second light beam from a second light emitting source of the array 302, and so on). Collimation of the light beams from the array 302 can increase the effective brightness of the light, can reduce divergence of the light beam, can eliminate or reduce blur (or astigmatism), can improve wavefront quality, can make the beam less elliptical, and can focus the light beams (e.g., to focus the light beams onto the tessellation DOE 308 described below).

In some examples, a primitive pattern can be periodic. For example, the code primitive may be replicated or repeated one or more times in one or more directions (e.g., horizontally and/or vertically) to fill the transmitter FOV (e.g., the FOV of the system 310). In some examples, a tessellation DOE 308 can be used to tessellate (or replicate) the primitive pattern projected by the array 302 of light emitting sources. The tessellation DOE 308 can have a template designed to generate and emit multiple replicas of the coded pattern by generating multiple copies of the primitive pattern in a side-by-side manner (e.g., with the primitive pattern being repeated horizontally and/or vertically).

FIG. 4A is a diagram illustrating an example of a 24×36 coded primitive pattern 402 of light generated by the array 302 of light emitting sources and collimated using the lens 306. The primitive pattern 402 (the desired primitive) is what the system 300 desires to have at the output of the transmitter. The black dots represent points of light. FIG. 4B is a diagram illustrating a projected pattern 403 of light (e.g., projected using the transmitter shown in FIG. 3A). The projected pattern 403 has the same pattern as the primitive pattern 402. The points of the projected pattern 403 are more spread out as compared to the points shown in the primitive pattern 402 due to the focal length of the transmitter. For example, as noted above, a longer focal length of the lens results in a higher resolution of the projected pattern (with the points being closer together).

FIG. 4B also illustrates a tessellated coded pattern 404 of light. The tessellated coded pattern 404 of light is generated by the tessellation DOE 308 replicating the projected pattern 403 of light (e.g., in order to fill in the transmitter field of view (FOV), such as the FOV of the system 300). For example, the center of the tessellated coded pattern 404 of light is the same as the projected pattern 403 of light, with the projected pattern 403 being replicated to the left, right, above, and below the center.

In many cases, a transmitter height of 7-8 mm is needed to achieve a high resolution coded depth pattern with sufficient power. Lens focal distance is an important factor contributing to transmitter height. As shown in FIG. 4B by the diagram 406, the focal distance needed for the tessellated coded pattern 404 of light of an appropriate resolution is approximately 6 mm. The 6 mm focal distance can be based on a typical resolution needed for face ID based authentication (e.g., a resolution of 240×160). For a focal distance of 6 mm, the total transmitter height is approximately 8 mm. As noted above, for mobile devices (e.g., smartphones), a transmitter height needs to be less than 5 millimeters (<5 mm). Similar issues can arise for other applications and devices.

To avoid such issues with respect to focal distance and transmitter height, the primitive pattern of light can be split into a number of sub-pattern groups, which in some cases can be referred to as quadrants (e.g., when a pattern of light is split into four sub-pattern groups). In one illustrative example, the primitive pattern can be divided into four sub-pattern groups (or four quadrants). The sub-pattern groups can be given a unique label according to an indexing technique (e.g., as shown in FIG. 5A, described below) used to split the pattern, such as odd/odd for a first sub-pattern group (including odd rows and odd columns from the pattern of light), odd/even for a second sub-pattern groups (including odd rows and even columns from the pattern of light), even/odd for the third sub-pattern groups (including even rows and odd columns from the pattern of light), even/even for a fourth sub-pattern groups (including even rows and even columns from the pattern of light). Any other suitable labels can be used, such as ++, −−, −+, +−. The primitive pattern can then be overlapped with itself by projecting the sub-pattern groups and overlapping the sub-pattern groups to produce an overlapped pattern. The overlapping can be performed by a tessellation DOE (e.g., in order to fill in the transmitter field of view (FOV)).

By splitting a coded pattern into sub-pattern groups and overlapping the sub-pattern groups using the tessellation DOE (effectively overlapping the primitive pattern with itself), the system can consume the same or similar amount of power as that used to generate the tessellated coded pattern 404 shown in FIG. 4B (due to the same pattern resolution being emitted), but can greatly reduce the lens focal distance and thus the transmitter height. For example, splitting a coded pattern into four sub-pattern groups (or quadrants) and overlapping the quadrants of patterns using the tessellation DOE, can reduce the lens focal distance by half (e.g., from 6 to 3 mm).

FIG. 3B is a diagram illustrating an example of a simplified structured light system 310 including a transmitter. The structured light system 310 can be implemented as part of the system 100 or the system 200. Similar to the system 300, the system 310 can be used for depth sensing to generate depth maps for various applications. The system 310 includes an array 312 of light emitting sources (or light emitters), also referred to as a structured light source. The array 312 projects optical beams of light 314 using the light emitting sources. The array 312 can include a regular or fixed grid (e.g., square grid, hexagonal grid, and/or other regular grid) of light emitting sources that are a fixed distance (e.g., 250 nanometers or other distance) apart from one another. The array 312 is similar to the array 302 of light emitting sources shown in FIG. 3A, but can have a different pattern of light emitting sources. For example, a primitive pattern of light can be divided into a number of sub-pattern groups. A split primitive pattern (or mask pattern) can be generated that includes the sub-pattern groups from the primitive pattern. Light emitting sources from the array 312 can be activated so that the split primitive pattern is projected by the array 312 of light emitting sources.

FIG. 5A is a diagram illustrating a primitive pattern 502 of light along with an indexing mechanism used to divide or split the primitive pattern 502 into sub-pattern groups. An array of 24×34 (row×columns) candidate light points is shown in FIG. 5A, with the primitive pattern 502 including a subset of all of the candidate light points. Each of the candidate light points shown in FIG. 5A corresponds to a light emitting source of the array 312. As noted above, the array 312 can include a regular (or fixed) grid of light emitting sources, with the distance between any two light emitting sources in the grid being equal to or greater than the minimum distance (e.g., 250 nm, 500 nanometers, or other distance). For instance, as shown in FIG. 5A, various index locations (e.g., (1,1), (2,1), (3,1), through (24,34)) represent the locations of the candidate light points (and the associated light emitting sources). Each candidate light point has a consistent distance (e.g., 250 nanometers, 500 nanometers, or other distance) relative to other candidate light points. Each of the light emitting sources of the array 312 (corresponding to the candidate light points of the primitive pattern 502) can be activated (e.g., turned on) or not activated in order to generate the primitive pattern 502 or a split primitive (described below). For example, as shown in FIG. 5A, the primitive pattern 502 includes activation of all light emitting sources in the third column (corresponding to indices (1,3) through (24,3)) and activation of every other light source in the first column (corresponding to indices (1,1) through (24,1)).

The index mechanism shown in FIG. 5A includes row and column indices, which are used to determine sub-pattern groups of the primitive pattern 502. Splitting the primitive pattern 502 into the sub-pattern groups results in a split primitive or split coded pattern of light (e.g., shown in FIG. 5B as a split primitive pattern 503 of light). The indexing shown in FIG. 5A includes a first value and a second value separated by a comma (e.g., (1,1), (2,1), (3,1), through (24,34)), where the first value corresponds to a row number and the second number corresponds to a column number within grid. The primitive pattern 502 of light can be split into sub-pattern groups using any suitable split. In one illustrative example, the primitive pattern 502 can be split into a first sub-pattern group that includes odd rows and odd columns (referred to as odd/odd), a second sub-pattern group that includes odd rows and even columns (referred to as odd/even), a third sub-pattern group that includes even rows and odd columns (referred to as even/odd), and a fourth sub-pattern group that includes even rows and even columns (referred to as even/even). An illustrative example is shown in FIG. 5B.

FIG. 5B is a diagram illustrating a split primitive pattern 503 of light (also referred to as a mask pattern) resulting from splitting of the primitive pattern 502 into four quadrants (or sub-pattern groups). As shown, the split primitive pattern 503 includes a first quadrant 505 that includes odd rows and odd columns from the primitive pattern 502 (e.g., including index values (1,1), (3,1), (5,1) . . . (23,33)), a second quadrant 507 that includes odd rows and even columns from the primitive pattern 502 (e.g., including index values (1,2), (3,2), (5,2) . . . (23,34)), a third quadrant 509 that includes even rows and odd columns from the primitive pattern 502 (e.g., including index values (2,1), (4,1), (6,1) . . . (24,33)), and a fourth quadrant 511 that includes even rows and even columns from the primitive pattern 502 (e.g., including index values (2,2), (4,2), (6,2) . . . (24,34)). The split primitive pattern 503 (the mask pattern) can be encoded into the light emitting sources of the array 312, resulting in light emitting sources of the array 312 being activated to project or emit the split primitive pattern 503 including the quadrants 505, 507, 509, and 511.

The light emitting sources from the array 312 that correspond to the split primitive pattern 503 of FIG. 5B can be activated (turned on), resulting in projection of the split primitive pattern 503 by the array 312. The beams of light emitted from the light emitting sources of the array 312 in the split primitive pattern 503 can be collimated (or aligned) using a lens 316. In some cases, as shown in FIG. 3B, a single lens 316 can be used to collimate or align the light beams from the array 312 of light emitting sources. In some cases, a separate microlens can be provided for each light emitting source, similar to that described above with respect to FIG. 3A.

In some examples, a tessellation DOE 318 can be used to tessellate (or replicate) the split primitive pattern 503 projected by the array 312 of light emitting sources and collimated by the lens 316. The tessellation DOE 318 can have a template designed to generate and emit multiple replicas of the split primitive pattern 503 by overlapping the split primitive pattern 503 with itself. For example, the tessellation DOE 318 can overlap the quadrants 505-511 of different replicas of the split primitive pattern 503 to produce an overlapped pattern. An example of an overlapped pattern 514 is shown in FIG. 5C, described in more detail below. The tessellation DOE 318 can overlap the quadrants 505-511 of different replicas of the split primitive pattern 503 in multiple directions, resulting in a projected pattern being replicated (or tessellated) in order to fill in FOV of the transmitter shown in FIG. 3A. An example of a projected pattern 512 is shown in FIG. 5C and is described in more detail below. The overlapped pattern has the same pattern as the coded primitive repeated a number of times according to the design of the diffractive optical element.

FIG. 5C is a diagram illustrating a projected pattern 512 (e.g., based on projection of the split primitive pattern 503 by the system 310 shown in FIG. 3B) having the same pattern as the split coded pattern 503 of light including the four quadrants shown in FIG. 5B. As noted above, the overlapped pattern 514 of light is generated by the tessellation DOE 318, which overlaps the four quadrants of the split primitive pattern 503 of light over one another by a certain overlap amount or percentage (the percentage of the overlap shown in FIG. 5C is 50%). FIG. 5D is a diagram illustrating the split primitive pattern 503 being overlapped with itself by 50%. As shown, the tessellation DOE 318 overlaps a first copy of the split coded pattern (denoted in FIG. 5D as 503-1) with a second copy of the split coded pattern (denoted in FIG. 5D as 503-2). In particular, the tessellation DOE 318 overlaps quadrants 505 and 507 in the first copy 503-1 of the split coded pattern with the quadrants 509 and 511 in the second copy 503-2 of the split coded pattern. The overlapped portion is shown in FIG. 5D as “509/505” and “511/505” with a hatched pattern. The 50% overlapping can also be performed by the tessellation DOE 318 in the left direction (e.g., with quadrants 509 and 511 in one copy of the split coded pattern being overlapped with quadrants 505 and 507 of another copy of the split coded pattern), in an upward direction (e.g., with quadrants 507 and 511 in one copy of the split coded pattern being overlapped with quadrants 505 and 509 of another copy of the split coded pattern), in a downward direction (e.g., with quadrants 505 and 509 in one copy of the split coded pattern being overlapped with quadrants 507 and 511 of another copy of the split coded pattern), etc.

Returning to FIG. 5C, an overlapped pattern 514 of light (also referred to as an overlapped pattern) is shown. The center of the overlapped pattern 514 includes the desired primitive pattern 502 of light, based on the projected pattern 512 being replicated by overlapping the sub-pattern groups or quadrants of the split primitive pattern 503. For instance, the template of the tessellation DOE 318 is designed so that overlapping the split primitive pattern 503 results in the overlapped pattern 514 (including the desired primitive pattern 502) being projected into space. The projected overlapped pattern 514 can reflect off of objects in a scene, and the reflected points can be used for determining depth of the scene (as described below). In some cases, the overlapped pattern 514 of light is a shifted version of the tessellated coded pattern 404, due to the overlapped pattern 514 of light being generated using the overlapping quadrants 505-511 shown in FIG. 5B. As shown in FIG. 5C by the diagram 506, the focal distance needed for the overlapped pattern 514 of light of an appropriate resolution is approximately 3 mm, corresponding to a transmitter height of approximately 4-5 mm.

The split primitive pattern 503 in shown in FIG. 5B and the primitive pattern 502 shown in FIG. 5A have a same size, in which case using the split primitive pattern 503 for the array 312 does not negatively affect the lens focal distance (or length) and/or size of the transmitter of FIG. 3B. As the lens focal distance of the transmitter becomes smaller (resulting in a smaller transmitter), a FOV of the transmitter and thus the size of an array of light projected by the array 312 will become larger and thus less dense. For instance, reducing the lens focal distance of the transmitter results in the points of the projected pattern 512 of FIG. 5C (representing a projection of the split primitive pattern 503 projected using the 3 mm transmitter shown in FIG. 3B) being less dense (with more distance between the dots) as compared to the projected pattern 403 of FIG. 4B (representing a projection of the primitive pattern 402 projected using the 6 mm transmitter shown in FIG. 3A).

In some cases, it can be beneficial to project a tessellated pattern with a higher density (e.g., for higher resolution applications). However, as noted above, reducing the lens focal length of a transmitter results in less dense points being projected by the transmitter (e.g., as shown by the projected pattern 512 in FIG. 5C). The sub-pattern group overlapping technique described above can be used to provide a higher density even when the focal length is reduced. For instance, by using the tessellation DOE 318 to overlap the split primitive pattern 503 with itself (e.g., as shown in FIG. 5C and FIG. 5D), a denser pattern of points is projected into space. The density of the projected points is increased by an amount corresponding to the amount of overlap. In one illustrative example, overlapping the split primitive pattern 503 with itself by an amount of 50% produces an overlapped pattern 514 with an increase in density of 50%, resulting in the overlapped pattern 514 having a same density as that the tessellated coded pattern 404 of FIG. 4B. Thus, by splitting the primitive pattern 502 into a split primitive pattern including sub-pattern groups (e.g., the split primitive pattern 503 including the quadrants 505-511 shown in FIG. 5B) and overlapping the sub-pattern groups using the tessellation DOE 318, the focal distance of the lens and the resulting transmitter size can be reduced (by an amount that is based on the number of sub-pattern groups) without reducing the density or resolution of the projected light. As shown in FIG. 3B, the focal distance or length of the transmitter is 3 mm, which is half of the focal distance of the transmitter shown in FIG. 3A.

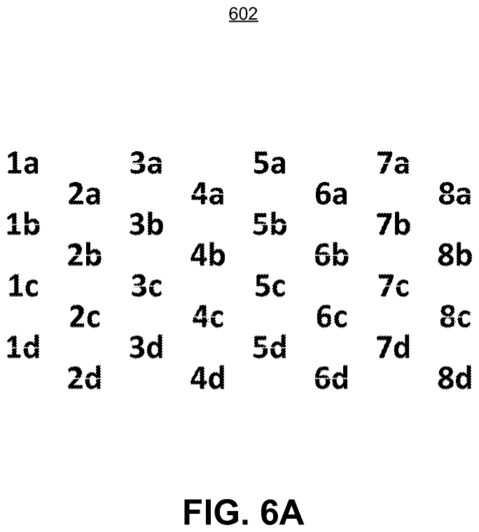

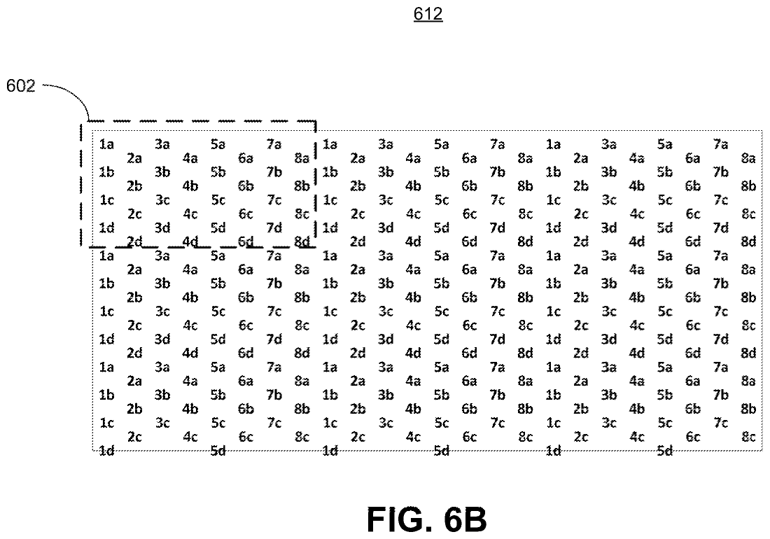

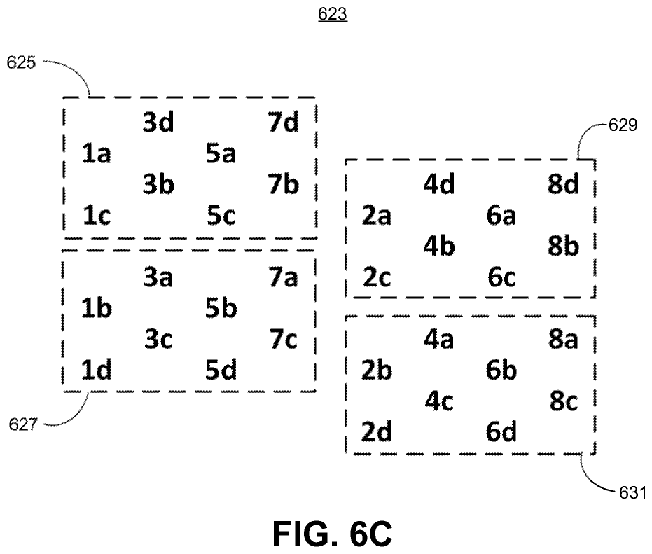

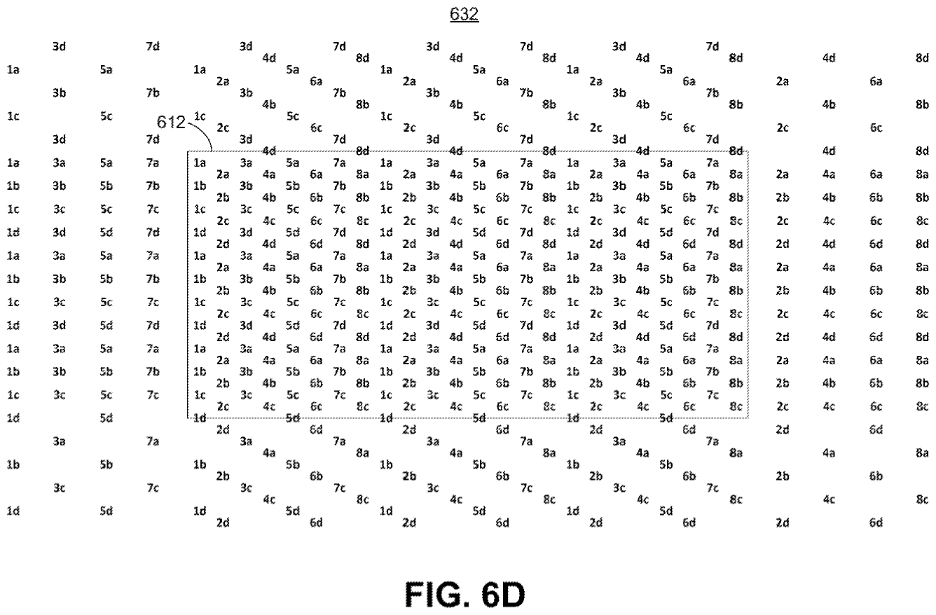

FIG. 6A is a diagram illustrating another example of a coded primitive pattern 602 of light. The different points are shown in FIG. 6A with different variables defining candidate light points on an array of light emitting sources, including 1a, 1b, 1c, 1d, 2a, 2b, 2c, 2d, and so on, where a value of a particular variable can have a value of 1 (when a corresponding candidate light point is turned on or activated) or a value of 0 (when a corresponding candidate light point is not turned on or activated). FIG. 6B is a diagram illustrating a tessellated coded pattern of light 612 generated by a tessellation DOE tessellating or replicating the primitive pattern 602. As shown, the tessellated coded pattern of light 612 includes multiple replicas of the primitive pattern 602. One iteration of the primitive pattern 602 is emphasized in FIG. 6B.

FIG. 6C is a diagram illustrating a split primitive pattern 623 of light generated by splitting or dividing the primitive pattern 602 of light into four sub-pattern groups, including sub-pattern group 625, sub-pattern group 627, sub-pattern group 629, and sub-pattern group 631. As described herein, any number of sub-pattern groups or quadrants can be generated, such as two, four, or other suitable number. The sub-pattern groups can be derived from a desired final primitive pattern (e.g., the primitive pattern 602 of FIG. 6A) using a mapping algorithm (e.g., according to the indexing described above, such as that shown in FIG. 5A). A tessellation DOE can then be used to overlap the sub-patterns, resulting in the desired pattern (from FIG. 6A). FIG. 6D is a diagram illustrating how the sub-pattern groups 625, 627, 629, and 631 are overlapped (using 50% overlap) to generate an overlapped pattern 632. As shown in FIG. 6D, the desired pattern (e.g., the tessellated coded pattern of light 612 shown in FIG. 6B) is complete only where full overlap occurs (at the center).

The tessellation DOE 318 can be designed or configured to perform various amounts of overlap when overlapping the sub-pattern groups of codes. As described above, tessellation DOE 318 can be configured to perform 50% overlap of the split primitive pattern 503. An example illustrating how 50% (2×) overlap works will be provided. For instance, given a primitive pattern that is to be generated (e.g., 24×34 candidate light points, with 52% of the candidate light points being on or activated), the primitive pattern can be separated into a split primitive pattern having four quadrants (or sub-pattern groups), as shown in FIG. 5B and FIG. 5C. The four quadrants can include Quadrant 1,1 (with odd rows and odd columns from the primitive), Quadrant 1,2 (with odd rows and even columns from the primitive), Quadrant 2,1(with even rows and odd columns from the primitive), and Quadrant 2,2 (with even rows and even columns from the primitive). The quadrants can then be overlapped or otherwise joined by the tessellation DOE 318 (e.g., as shown in FIG. 5D). In some cases, the quadrants can be overlapped with a particular amount of horizontal and/or vertical separation between the light points (e.g., by an amount equal to the horizontal and/or vertical distance between light emitting sources on the array).

The tessellation DOE 318 can be configured to perform any other suitable amount of overlap of a split primitive pattern. In an example using 3× overlap (where R is the row number and C is the column number), a primitive pattern can be separated into nine sub-pattern groups or quadrants, including the following: Quadrant 1,1 (with R %3=1 rows, C %3=1 columns); Quadrant 1,2 (with R %3=1 rows, C %3=2 columns); Quadrant 1,3 (with R %3=1 rows, C %3=0 columns); Quadrant 2,1 (with R %3=2 rows, C%3=1 columns); through Quadrant 3,3 (with R %3=0 rows, C %3=0 columns). The “%” notation refers to a modulo (or modulus) operation. The modulo operation can be defined as x mod y=r (also denoted as x % y=r), where x is the dividend, y is the divisor (or modulus), and r is the remainder. For example, R %3 is row number modulo 3 and R %3=1 are columns 1, 4, 7, 10, etc.

A depth map can be generated by the systems 100, 200, and/or 300 based on an overlapped pattern (e.g., the overlapped pattern 514 of light) that is projected into the space of a scene or environment. For example, an image sensor of the receiver 202 shown in FIG. 2 can capture a frame or image that includes one or more reflections of the overlapped pattern (e.g., a projected code mask). The captured frame can be provided to the light controller 210, and the image signal processor 212 can generate a set of depth values based on the captured frame. For instance, the image signal processor 212 can generate a depth map based on the captured frame by identifying codes of the distribution of light in the captured frame, and determining depths of one or more objects in the scene based on the identified codewords.

In some cases, as noted above, a transmitter can project a light field through a code mask (e.g., based on the configuration of the array 312 of light emitting sources) to project codewords on an object or scene. A receiver can capture return signals that include the codewords within the projected code mask. For example, the overlapped pattern 514 (which includes the desired pattern primitive 502 based on the overlapping technique described above) can be projected onto a target object or scene, and the reflected light from the target object or scene can be captured by the receiver as an image (e.g., a code mask image). The received image can be analyzed to determine depth information of the object or scene. For instance, the captured image of the scene or object can be decoded to obtain a depth map for the scene or object. In some cases, a section of the overlapped pattern 514 is projected onto the surface of an object or scene, and the projected section may then be captured by the receiver as a captured segment. The section may be used as a codeword that can be uniquely identified. In such cases, by covering the scene or object with unique codewords, sections of the scene or object can be identified and may be used for depth sensing.

Based on the image captured by the receiver, multiple segments may be identified over the scene or object. The receiver can uniquely identify each segment and can determine the location of each segment relative to other segments from the known pattern of the code mask. In some cases, a code from each segment can be determined using pattern segmentation (e.g., to address distortion) by decoding of the perceived segment into one or more corresponding codes. In some examples, triangulation may be applied over each captured segment to determine an orientation and/or depth. Multiple segments can be combined to stitch together a captured image pattern in order to generate a depth map.

In some cases, based on the technique described above to split a tessellated coded pattern into a number of quadrants and overlapping the quadrants, similar performance and complexity can be achieved as compared to coded patterns that are generated without splitting and overlapping (referred to as regular tessellation). For example, the complexity to make a transmitter thinner is pushed to the light emitting array (e.g., VCSel array) design and manufacturing. The light emitting array design can be different, but with comparable complexity relative to regular tessellation. Further, the DOE and lens designs are different for systems implementing the techniques described herein, but have comparable complexity relative to tessellation DOEs that do not overlap a primitive pattern with itself. For systems implementing the techniques described herein, there is also no need for additional elements (e.g., prisms) when compared to the folded optics techniques noted above that fold the optical path to reduce height of the transmitter, making a transmitter of such systems easier and more economical to assemble (e.g., there is no prism to mount). The transmitter dimensions (e.g., XY dimensions) are also significantly smaller than the folded optics based systems, as noted above.

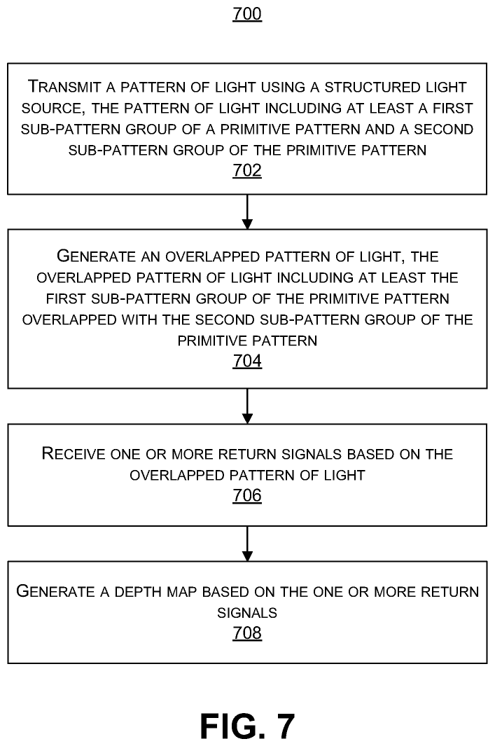

FIG. 7 is a flowchart illustrating an example of a process 700 of generating one or more depth maps using one or more of the structured light code overlay techniques described herein. At block 702, the process 700 includes transmitting a pattern of light using a structured light source. In some aspects, the structured light source includes a regular (or fixed) grid of light emitting sources (e.g., with the distance between any two light emitting sources in the grid being equal to or greater than a minimum distance, such as 250 nm, 500 nanometers, or other distance). The pattern of light includes at least a first sub-pattern group of a primitive pattern of light and a second sub-pattern group of the primitive pattern. In some implementations, the pattern of light is based on light generated by the structured light source and passed through a lens configured to collimate the light generated by the structured light source. For example, the lens can include the lens 316 shown in FIG. 3B. The lens 316 can be used to collimate the light beams from the array 312 of light emitting sources. The primitive pattern of light can be split into any suitable number of sub-pattern groups of the primitive pattern. In one illustrative example, primitive pattern can be split into the first sub-pattern group of the primitive pattern, the second sub-pattern group of the primitive pattern, a third sub-pattern group of the primitive pattern, and a fourth sub-pattern group of the primitive pattern, resulting in the transmitted pattern of light including the first, second, third, and fourth sub-pattern groups of the primitive pattern. Referring to FIG. 5A and FIG. 5B as an illustrative example, the primitive pattern 502 of light can be split into a split primitive pattern 503 including a first quadrant 505 (or first sub-pattern group), a second quadrant 507 (or second sub-pattern group), a third quadrant 509 (or third sub-pattern group), and a fourth quadrant 511 (or fourth sub-pattern group). The split primitive pattern 503 can then be transmitted at block 702.

At block 704, the process 700 includes generating an overlapped pattern of light. The overlapped pattern of light includes at least the first sub-pattern group of the primitive pattern overlapped with the second sub-pattern group of the primitive pattern. In the illustrative example above where the pattern of light is split into the first sub-pattern group of the primitive pattern, the second sub-pattern group of the primitive pattern, the third sub-pattern group of the primitive pattern, and the fourth sub-pattern group of the primitive pattern, generating the overlapped pattern includes overlapping the first sub-pattern group of the primitive pattern with the second sub-pattern group of the primitive pattern, the third sub-pattern group of the primitive pattern, and the fourth sub-pattern group of the primitive pattern. In some examples, generating the overlapped pattern includes tessellating (or replicating) the pattern of light using a diffractive optical element configured to replicate the pattern of light. For example, the DOE can include the tessellation DOE 318 designed to emit multiple replicas of a coded pattern (e.g., the primitive pattern of light). Referring to FIG. 5C as an illustrative example, the overlapped pattern 514 of light is generated by overlapping the four quadrants of the split primitive pattern 503 over one another by a certain overlap amount or percentage (the example of FIG. 5A-FIG. 5D includes a 50% overlap amount), and tessellating the overlapped pattern. Another illustrative example of different sub-pattern groups being overlapped is shown in FIG. 6A-FIG. 6D.

At block 706, the process 700 includes receiving one or more return signals (e.g., a code mask image) based on the overlapped pattern of light. At block 708, the process 700 includes generating a depth map based on the one or more return signals. For instance, the depth map can be derived from a received image of the projected overlapped sub-patterns. In one example, as described above, the depth map can be generated based on a captured image or frame of projected overlapped sub-patterns at least in part by identifying codewords of the distribution of light in the captured image or frame, and determining depths of one or more objects in the scene based on the identified codewords.

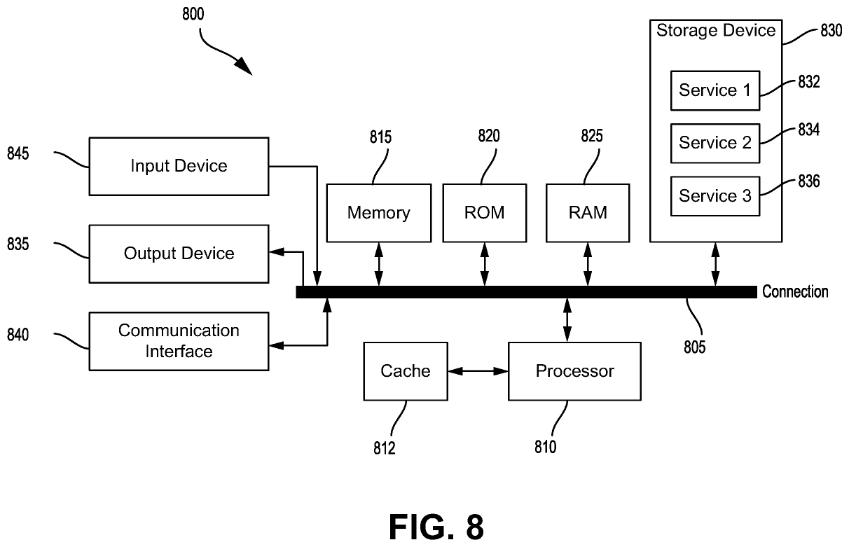

In some examples, the processes described herein (e.g., process 700 and/or other process described herein) may be performed by a computing device or apparatus, such as a computing device having the computing device architecture 800 shown in FIG. 8. In some examples, the computing device can include a mobile device, a wearable device, an extended reality device (e.g., a virtual reality (VR) device, an augmented reality (AR) device, or a mixed reality (MR) device), a personal computer, a laptop computer, or other device. In one example, the process 700 can be performed by a computing device with the computing device architecture 800 implementing the system 100, the system 200, or the system 300. The computing device can include any suitable device, such as an autonomous vehicle, a robotic device, a mobile device (e.g., a mobile phone), a desktop computing device, a tablet computing device, a wearable device, and/or any other computing device with the resource capabilities to perform the processes described herein, including process 700.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include the lens configured to collimate the light generated by the structured light source, the diffractive optical element configured to replicate the light, a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (including process 700) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, or other device. For example, the computing device architecture 800 can implement the system 100, the system 200, or the system 300. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific examples. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method of generating one or more depth maps, the method comprising:
transmitting a pattern of light using a structured light source, the pattern of light including at least a first sub-pattern group of a primitive pattern and a second sub-pattern group of the primitive pattern;
generating an overlapped pattern of light, the overlapped pattern of light including at least the first sub-pattern group of the primitive pattern overlapped with the second sub-pattern group of the primitive pattern;
receiving one or more return signals based on the overlapped pattern of light; and
generating a depth map based on the one or more return signals.

2. The method of claim 1, wherein the pattern of light is based on light generated by the structured light source and passed through a lens configured to collimate the light generated by the structured light source.

3. The method of claim 1, wherein generating the overlapped pattern of light includes tessellating the pattern of light using a diffractive optical element configured to replicate the pattern of light.

4. The method of claim 1, wherein the pattern of light includes the first sub-pattern group of the primitive pattern, the second sub-pattern group of the primitive pattern, a third sub-pattern group of the primitive pattern, and a fourth sub-pattern group of the primitive pattern, and wherein generating the overlapped pattern of light includes overlapping the first sub-pattern group of the primitive pattern with the second sub-pattern group of the primitive pattern, the third sub-pattern group of the primitive pattern, and the fourth sub-pattern group of the primitive pattern.

5. The method of claim 1, wherein the one or more return signals include a received image of the overlapped pattern of light.

6. The method of claim 1, wherein the structured light source includes a regular grid of light emitting sources.

7. An apparatus for generating one or more depth maps, comprising:
a memory;
a structured light source configured to transmit a pattern of light, the pattern of light including at least a first sub-pattern group of a primitive pattern and a second sub-pattern group of the primitive pattern;
an optical device configured to generate an overlapped pattern of light, the overlapped pattern of light including at least the first sub-pattern group of the primitive pattern overlapped with the second sub-pattern group of the primitive pattern; and
a processor coupled to the memory and configured to:
obtain one or more return signals based on the overlapped pattern of light; and
generate a depth map based on the one or more return signals.

8. The apparatus of claim 7, further comprising a lens configured to collimate the light generated by the structured light source, wherein the pattern of light is based on light generated by the structured light source and passed through the lens.

9. The apparatus of claim 7, wherein the optical device is configured to generate the overlapped pattern of light at least in part by tessellating the pattern of light.

10. The apparatus of claim 7, wherein the optical device is a diffractive optical element.

11. The apparatus of claim 7, wherein the pattern of light includes the first sub-pattern group of the primitive pattern, the second sub-pattern group of the primitive pattern, a third sub-pattern group of the primitive pattern, and a fourth sub-pattern group of the primitive pattern, and wherein the optical device is configured to generate the overlapped pattern of light at least in part by overlapping the first sub-pattern group of the primitive pattern with the second sub-pattern group of the primitive pattern, the third sub-pattern group of the primitive pattern, and the fourth sub-pattern group of the primitive pattern.

12. The apparatus of claim 7, wherein the one or more return signals include a received image of the overlapped pattern of light.

13. The apparatus of claim 7, wherein the structured light source includes a regular grid of light emitting sources.

14. The apparatus of claim 7, wherein the apparatus comprises a mobile device.

15. The apparatus of claim 7, wherein the apparatus comprises a wearable device.

16. The apparatus of claim 7, wherein the apparatus comprises an extended reality device.

17. The apparatus of claim 7, further comprising a display.

18. A computer-readable storage medium storing instructions that when executed cause one or more processors to:
cause an overlapped pattern of light to be emitted based on a pattern of light transmitted by a structured light source, the pattern of light including at least a first sub-pattern group of a primitive pattern and a second sub-pattern group of the primitive pattern, and the overlapped pattern of light including at least the first sub-pattern group of the primitive pattern overlapped with the second sub-pattern group of the primitive pattern;
obtain one or more return signals based on the overlapped pattern of light; and
generate a depth map based on the one or more return signals.

19. The computer-readable storage medium of claim 18, wherein the pattern of light is based on light generated by the structured light source and passed through a lens configured to collimate the light generated by the structured light source.

20. The computer-readable storage medium of claim 18, wherein the overlapped pattern of light is generated based on tessellating the pattern of light using a diffractive optical element configured to replicate the pattern of light.

21. The computer-readable storage medium of claim 18, wherein the pattern of light includes the first sub-pattern group of the primitive pattern, the second sub-pattern group of the primitive pattern, a third sub-pattern group of the primitive pattern, and a fourth sub-pattern group of the primitive pattern, and wherein the overlapped pattern of light is generated at least in part based on overlapping the first sub-pattern group of the primitive pattern with the second sub-pattern group of the primitive pattern, the third sub-pattern group of the primitive pattern, and the fourth sub-pattern group of the primitive pattern.

22. The computer-readable storage medium of claim 18, wherein the one or more return signals include a received image of the overlapped pattern of light.

23. The computer-readable storage medium of claim 18, wherein the structured light source includes a regular grid of light emitting sources.
